(19) United States
(12) Patent Application Publication
(10) Pub. No.: US 2019/0039216 A1
(43) Pub. Date: Feb. 7, 2019

(54) KEY WRENCH

(71) Applicant: MITSUBISHI HEAVY INDUSTRIES, LTD., Tokyo (JP)

(72) Inventors: Akira IKADA, Tokyo (JP); Toyohiko KONO, Tokyo (JP); Koya NOMURA, Tokyo (JP)

(21) Appl. No.: 16/075,412

(22) PCT Filed: Jan. 6, 2017
(86) PCT No.: PCT/JP2017/000282

§ 371 Date: Aug. 3, 2018

(30) Foreign Application Priority Data
Apr. 21, 2016 (JP) 2016-085373

(51) Int. Cl. B25B 23/10; B25B 15/00; B25B 13/48

(52) U.S. Cl. CPC B25B 23/108; B25B 13/488; B25B 15/008

(57) ABSTRACT

It is supposed that N is defined as an optional natural number equal to or more than 3. A key wrench has a key section 5-2 engageable with a socket 2 of an N-sided polygon, and a proximal section 5-1. The key section 5-2 has N side surfaces that contain a first side surface 50-1, a second side surface 50-2 and an N^{th} side surface 50-N. The first side surface 50-1 is a tapered surface, and the N^{th} side surface 50-N is a non-tapered surface. Thus, the key wrench is provided to restrain a transformation of the surface of the socket and a generation of an excessive cam out load.

### TECHNICAL FIELD

The present invention relates to a key wrench.

### BACKGROUND ART

It is known to operate a fastening member having a hexagonal socket by using, for example, a key wrench having a key engageable with the hexagonal socket. FIG. 1 (cross-sectional view') shows a hexagonal socket 2′ of a fastening member 1′ and a key section of a key wrench 5′. The cross-sectional shape of the key section is formed to be smaller than the cross-sectional shape of the hexagonal socket 2′. Therefore, as shown in FIG. 1, a corner section 6′ of the key section contacts a surface 3′ defining the hexagonal socket 2′ in a small area. As a result, a large stress concentration occurs in a portion corresponding to the small area. Therefore, the surface 3′ defining the hexagonal socket 2′ transforms due to the corner section 6′ of the key section.

When the fixation or detachment of the fastening member 1′ is carried out once or more, the transformation of surface 3′ progresses so that there is a fear that it becomes impossible to operate (fix or detach) the fastening member 1′ with the key wrench. FIG. 2 shows an example that the shape of the surface 3′ defining the hexagonal socket 2′ is changed to a circular shape, as shown by a reference numeral 3″, after the fixation or detachment of the fastening member 1′ is carried out plural times.

As the related technique, Patent Literature 1 discloses a wrench. The wrench disclosed in Patent Literature 1 has an operating section and an acting section. The acting section has a hexagonal pyramid shape that becomes thinner for the tip. The side surface of the acting section is inclined with respect to the axis of the acting section. The fitness between the acting section and the hexagonal socket of a screw member is improved because of such a configuration.

### CITATION LIST

### Patent Literature

[Patent Literature 1] JP 2000-52264A

### SUMMARY OF THE INVENTION

An object of the present invention is to provide a key wrench that restrains a transformation of the surface of a socket and an occurrence of an excessive cam out load.

The object, other objects except for the object and profits of the present invention can be easily confirmed by the following description and the attached drawings.

The key wrench in some embodiments includes: a key section engageable with a socket of an N-sided polygon when N is an optional natural number equal to or more than 3; and a proximal section.

The key section has N side surfaces that contain a first side surface, a second side surface and an N^{th} side surface. The first side surface is a tapered surface, and the N^{th} side surface is a non-tapered surface.

In the above key wrench, the key section may contain a third side surface. Also, at least one of the second side surface and the third side surface may be a tapered surface. Also, the N side surfaces other than the first side surface, the second side surface and the third side surface may be the non-tapered surfaces.

In the above key wrench, the second side surface may be the tapered surface and the third side surface may be the non-tapered surface.

In the above key wrench, the second side surface may be the tapered surface. The first side surface that is the tapered surface and the second side surface that is the tapered surface may be adjacent to each other.

In the above key wrench, a taper angle of the side surface may be from 1° to 2.5°.

In the above key wrench, a cross section of the key section that is perpendicular to a longitudinal direction axis may contain two or more sides that overlap any of the N sides of a virtual regular N-sided polygon, and at least one side that is situated out of the virtual regular N-sided polygon.

The key wrench in some embodiments includes: a key section engageable with a socket of an N-sided polygon when N is an optional natural number equal to or more than 3; and a proximal section. The key section has N side surfaces that contain a first side surface, a second side surface and an N^{th} side surface. The first side surface has a first tapered surface inclined to a first axis that is a longitudinal direction central axis of the key section. An. N^{th} taper angle that is an angle between the N^{th} side surface and the first axis is smaller than a first taper angle that is an angle between the first side surface and the first axis.

According to the present invention, the key wrench can be provided to restrain a transformation of the surface of the socket and an occurrence of an excessive cam out load.

### BRIEF DESCRIPTION OF THE DRAWINGS

FIG. 1 is a schematic cross-sectional view showing a situation that the stress concentration occurs on the surfaces defining a socket by using a conventional key wrench.

FIG. 2 is a schematic cross-sectional view showing a situation that the shape of the surfaces defining the socket is transformed largely by using the conventional key wrench.

FIG. 3 is a cross-sectional view of a key section along a plane perpendicular to a longitudinal direction of the key section to show a central axis of the key section in the longitudinal direction.

FIG. 4 is a longitudinal cross-sectional view of the key section showing the central axis of the key section in the longitudinal direction and a taper angle.

FIG. 5 is a diagram showing items recognized by the inventors.

FIG. 6 is a schematic perspective view showing the key wrench in an embodiment.

FIG. 7 is a longitudinal cross-sectional view showing a situation that the key section of a key wrench 5 is inserted in the socket.

FIG. 8 is a cross-sectional view of the key wrench along a plane A in FIG. 6.

FIG. 9 is a bottom view schematically showing a modification example of the key wrench in the embodiment.

FIG. 10A is a schematic bottom view of the key section of the key wrench in a first example.

FIG. 10B is a schematic bottom view of the key section of the key wrench in a second example.

FIG. 10C is a schematic bottom view of the key section of the key wrench in a third example.

FIG. 10D is a schematic bottom view of the key section of the key wrench in a fourth example.

FIG. 10E is a schematic bottom view of the key section of the key wrench in a fifth example.

FIG. 10F is a schematic bottom view of the key section of the key wrench in a sixth example.

FIG. 11 is a longitudinal cross-sectional view showing an application example of the key wrench.

FIG. 12 is a schematic perspective view showing an application example of the key wrench.

FIG. 13 is a longitudinal cross-sectional view showing the overview of an experiment apparatus.

FIG. 14 is a diagram of graphs showing a relation of taper angle and torque when the socket is destroyed to show an analysis result.

FIG. 15 is a diagram of graphs showing a relation of torque and cam out load to show the analysis result.

FIG. 16 is a diagram of graphs showing a relation of taper angle, torque when the socket begins to be transformed, torque when the socket is destroyed, and torque when the cam out load becomes 10 kgf in the first example to the sixth example to show the analysis result.

FIG. 17 is a diagram of graphs showing a relation of the number of tapered surfaces and torque when the socket is destroyed to show the experiment result.

FIG. 18 is a diagram of graphs showing a relation of taper angle and torque when the socket is destroyed to show an experiment result.

### DESCRIPTION OF EMBODIMENTS

Hereinafter, a key wrench according to embodiments will be described with reference to the attached drawings. Note that an identical reference numeral is assigned to a component having an identical function in the attached drawings. The repetitive description of the component having the identical reference numeral is omitted.

### (Definition of Terms)

In this Description, a direction heading for a proximal end from a distal end (a free end) of a key section of the key wrench is defined as “a first direction”. In this Description, “an upward direction” corresponds to the first direction. That is, in this Description, even when the first direction and the upward direction do not coincide with each other actually, “the first direction” is defined as the upward direction. Also, in this Description, “a downward direction (a second direction)” means a direction opposite to “the upward direction (the first direction)”.

In this Description, a longitudinal direction central axis L1 of the key section of the key wrench is interpreted according to the general technical common sense. When it is unclear that longitudinal direction central axis L1 of the key section of the key wrench corresponds to which of virtual straight lines even though interpreted according to the general technical common sense, the longitudinal direction central axis L1 of the key section is interpreted as follows:

(1) If at least one of cross sections that are perpendicular to the longitudinal direction of the key section of the key wrench is a regular polygon, the longitudinal direction central axis L1 of the key section means an axis that passes a center of the cross section of the regular polygon and perpendicular to the cross section of the regular polygon,

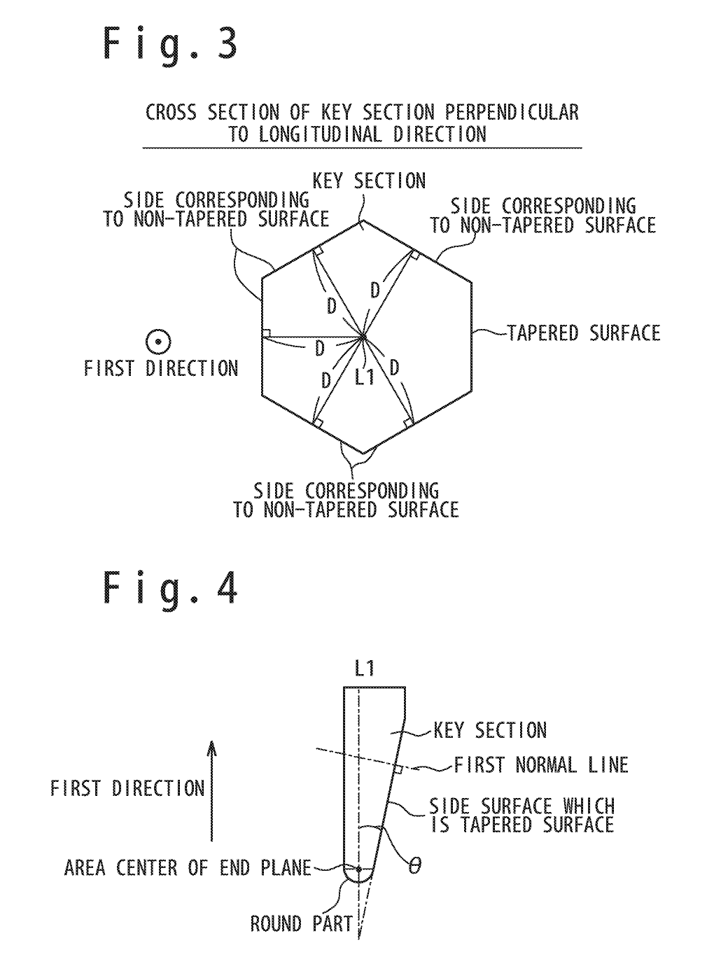

(2) if all of the cross sections that are perpendicular to the longitudinal direction of the key section of the key wrench are not a regular polygon, the longitudinal direction central axis L1 of the key section is defined as an axis that passes through a point of an equal distance from all the sides corresponding to a non-tapered surface, and that is perpendicular to one cross section, when an intersection line between one of cross sections perpendicular to the longitudinal direction of the key section and a side surface that is the non-tapered surface of side surfaces of the key section is defined as a side corresponding to the non-tapered surface (referring to FIG. 3, a distance between the longitudinal direction central axis L1 and the side corresponding to each non-tapered surface is D.), and

(3) when it is unclear that the longitudinal direction central axis L1 of the key section of the key wrench corresponds to which of virtual straight lines even if the above cases “(1)” and “(2)” are considered, the longitudinal direction central axis L1 of the key section is defined as an axis that passes through an area center of an end surface (a free end plane) of the key section of the key wrench, and that is perpendicular to the end surface. Note that when the end surface has a round part, the end surface part from which the round part is excluded is defined as the end surface (reference to FIG. 4).

In this Description, a taper angle of a side surface of the key section is defined as an angle θ between the side surface and the longitudinal direction axis (longitudinal direction central axis L1) of the key section, as shown in FIG. 4. More specifically, the angle θ is defined as an angle opposing to a first normal line in a triangle shaped by one of normal lines of the tapered surface that intersects with the central axis L1 (hereinafter, to be referred to “the first normal line”), an extension line of the central axis L1, and an intersection line of the tapered surface and a plane containing the first normal line and the extension line (reference to FIG. 4).

### (Matters Recognized by the Inventors)

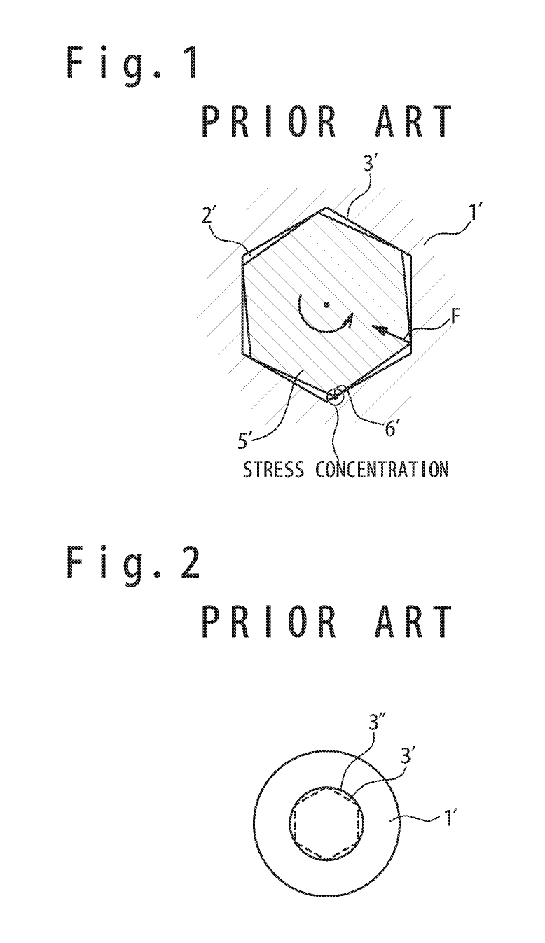

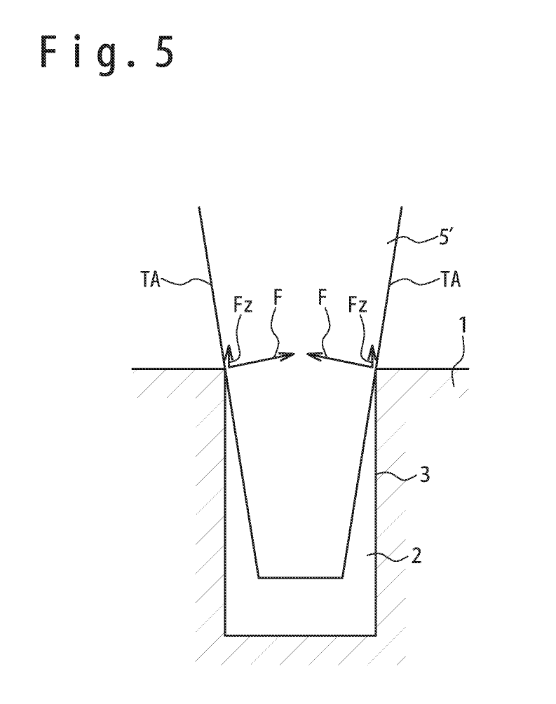

Referring to FIG. 5, it is supposed that a rotation torque is transmitted between the key wrench 5′ and the fastening member 1. In a state that the key wrench 5′ having tapered surfaces TA is inserted in the socket 2 of the fastening member 1. In this case, inward force F acts on the key wrench 5′ due to the rotation torque (if necessary, reference to the inward force F shown in FIG. 1). In this Description, an upward component (Fz) of the inward force is called “a cam out load”. When the cam out load is large, the load of a worker or a machine holding the key wrench becomes large. Especially, when the size (the cross-sectional area) of socket 2 is small, or when the rotation torque transmitted between the key wrench 5′ and the fastening member 1 is large, the problem of cam out load becomes conspicuous.

Note that FIG. 5 is a diagram to explain the matters recognized by the inventors, and is not a diagram showing a known problem.

### (Key Wrench in Embodiment)

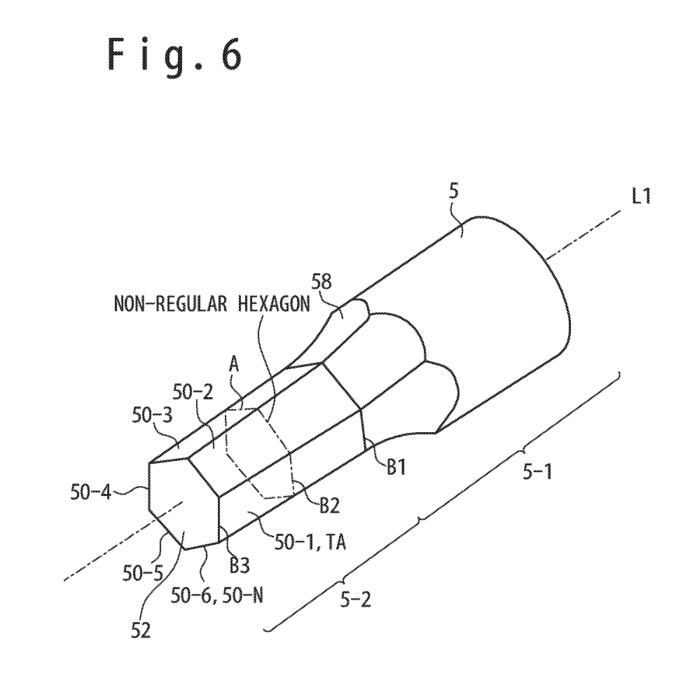

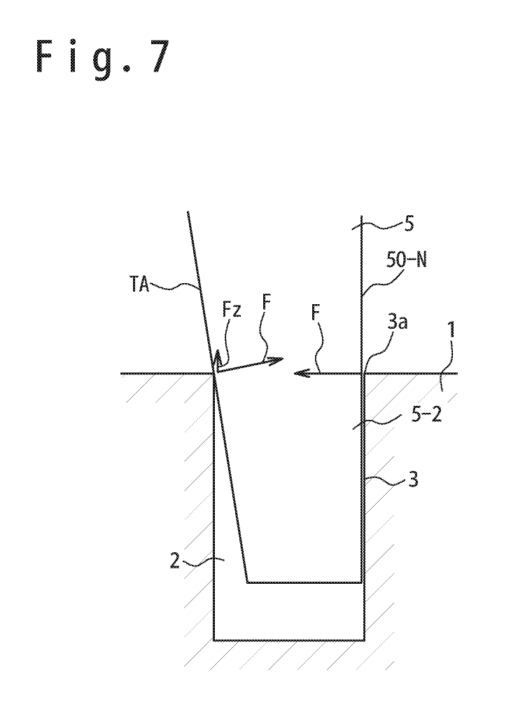

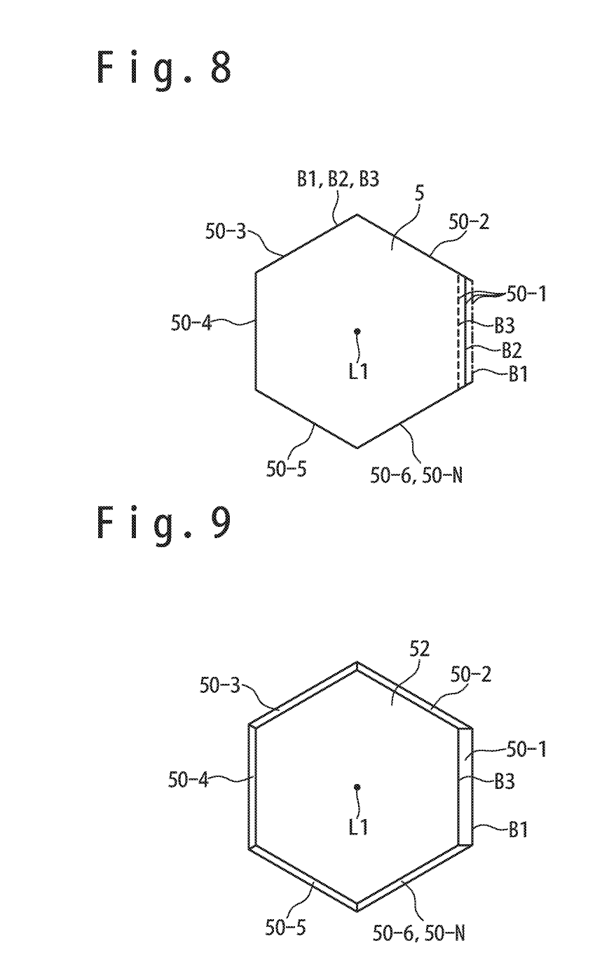

Referring to FIG. 6 to FIG. 8, the key wrench 5 in the embodiment will be described. FIG. 6 is a schematic perspective view of the key wrench 5 in the embodiment. FIG. 7 is a longitudinal cross-sectional view showing a state that the key section 5-2 of the the key wrench 5 is inserted in the socket 2. FIG. 8 is a cross-sectional view of the key wrench 5 along a plane A in FIG. 6 (a diagram showing the cross section of the key wrench perpendicular to the longitudinal direction central axis L1).

The key wrench 5 has a proximal section 5-1 and a key section 5-2. The proximal section 5-1 is a section that is held by a worker, a tool or a machine. The key section 5-2 is a section engageable with a socket of an N-sided polygonal shape, when N is defined as a natural number equal to or more than 3. To avoid explanation to become complicated, a case of N=6 will be described in the following description. That is, the case where the key wrench 5 is a hex wrench and the socket 2 is a hexagonal socket will be described. Note that in the explanation of this Description, it is possible to generalize the explanation by respectively reading a hexagon, a regular hexagon, a hexagonal socket, a sixth side surface and a sixth tapered angle as an N-sided polygon, a regular N-sided polygon, an N-sided polygonal socket, an N^{th} side surface and an N^{th} taper angle.

The proximal section 5-1 and the key section 5-2 are connected through a cross section B1 (a cross section perpendicular to the longitudinal direction central axis L1) in an example shown in FIG. 6, the cross section B1 is of a hexagon but is not of a regular hexagon.

A transition section 58 may be provided in a distal end section of the proximal section so that the cross section becomes small gradually for the tip (the cross-sectional area becomes smaller continuously) distal end section of the transition section 58 is connected with the key section 5-2. The occurrence of large stress concentration is restrained by the existence of the transition section 58 when a torque is transmitted between the key section 5-2 having a small cross-sectional area and the proximal section 5-1 having a large cross-sectional area.

A proximal end of the key section 5-2 of the key wrench 5 is connected with the proximal section 5-1, and a distal end of the key section 5-2 is a free end 52. The key section 5-2 has a first side surface 50-1 to a sixth side surface 50-6. That is, the key section 5-2 has the first side surface 50-1, a second side surface 50-2, a third side surface 50-3, a fourth side surface 50-4, a fifth side surface 50-5, and the sixth side surface 50-6. The first side surface 50-1 contains a tapered surface TA (a first tapered surface) inclined to the first axis that is the longitudinal direction central axis L1. A first taper angle that is an angle between the first side surface 50-1 and the first axis is desirably equal to or more than 1°.

The sixth side surface 50-6 of the key section 5-2 is a non-tapered surface. In the example shown in FIG. 6, the sixth taper angle that is an angle between the sixth side surface 50-6 and the longitudinal direction central axis L1 (the first axis) is 0°. In this Description, the surface that the taper angle is less than 1° or less than 0.5° may be contained in the non-tapered surfaces in addition to the surface that the taper angle is 0° (that is, an angle to the longitudinal direction central axis L1).

The key section 5-2 of the key wrench 5 in the embodiment has the first side surface that is a tapered surface and the sixth side surface that is a non-tapered surface. In other words, the taper angle of the sixth side surface is smaller than the taper angle of the first side surface. In the embodiment, because the key section has the side surface whose taper angle is 0° or a minute angle, a total value of cam out loads Fz can be made small, as shown in FIG. 7.

FIG. 8 is a cross-sectional view of the key wrench 5 along the plane A in FIG. 6. The cross section B2 of the key wrench 5 along the plane A is hexagonal but is non-regular hexagonal. The cross section B2 is a cross section corresponding to a portion contacting an opening edge 3a of the socket 2 (referring to FIG. 7) when the key section 5-2 is inserted in the socket 2. In FIG. 8, the cross section B1 showing the proximal end of the key section 5-2 of the key wrench 5 and the cross section B3 showing a free end of the key section 5-2 are shown for the reference. The cross section B2 is a cross section that is located between the cross section B1 and the cross section B3.

As would be seen from FIG. 8, the first side surface 50-1 that is a tapered surface is a surface in which the distance from the longitudinal direction central axis L1 becomes small as heading for the tip (the free end). Also, the first side surface 50-1 is a surface in which the distance from the side surface (the fourth side surface 50-4) opposing to the first side surface 50-1 becomes small as heading for the tip. On the other hand, when the taper angle of the sixth side surface 50-6 that is a non-tapered surface is 0°, the sixth side surface 50-6 is a surface in which the distance from the longitudinal direction central axis L1 does not change as heading for the tip (the free end). In the example shown in FIG. 8, the angle between the first side surface 50-1 and the side surface (the fourth side surface 50-4) opposing to the first side surface is larger than the angle between the sixth side surface 50-6 and the side surface opposing to the sixth side surface (the third side surface 50-3).

Referring to FIG. 8, in the cross section B2 corresponding to a part that contacts the opening end edge 3a of the socket in the key section 5-2, the distance between the first side surface 50-1 that is the tapered surface, and the longitudinal direction central axis L1 is larger than the distance between the sixth side surface 50-6 and the longitudinal direction central axis L1. Therefore, when the key section 5-2 is inserted in the socket 2, the first side surface 50-1 that is the tapered surface contacts the opening end edges of the socket.

Also, in the cross section B2, the distance between the first side surface 50-1 that is the tapered surface and the side surface opposing to the first side surface (the fourth side surface 50-4) is larger than the distance between the sixth side surface 50-6 and the side surface opposing to the sixth side surface (the third side surface 50-3). Therefore, when the key section 5-2 is inserted in the socket 2, the first side surface 50-1 that is the tapered surface (or, the first side surface 50-1 and the fourth side surface 50-4) contacts more surely contacts the opening end edge of the socket.

Also, in the example shown in FIG. 8, the first side surface 50-1 is located out of a virtual regular hexagon defined by the second side surface 50-2 to the sixth side surface 50-6 in the cross section B2. In other words, the cross section of the key section 5-2 perpendicular to the longitudinal direction axis (the longitudinal direction central axis L1) has two or more sides or three or more sides that overlap any of six sides that configure the virtual regular hexagon (refer to 50-2 50-3, 50-4, 50-5, 50-6 in FIG. 8) and at least one side that is located out of the virtual hexagonal-shaped having (refer to the solid line corresponding to 50-1 in FIG. 8).

In the cross section B3 corresponding to the free end of the key section 5-2, the first side surface 50-1 may be located inside or outside the virtual regular hexagon defined by the second side surface 50-2 to the sixth side surface 50-6. In the example shown in FIG. 8, in the cross section B3, the first side surface 50-1 is located on the virtual regular hexagon defined by the second side surface 50-2 to the sixth side surface 50-6. In other words, in the example shown in FIG. 8, the cross section B3 corresponding to the free end of the key section 5-2 is the regular hexagon.

In the example shown in FIG. 8, all of the second side surface 50-2 to the fifth side 50-5 are non-tapered surfaces, but one, two, three or four of the second side surface 50-2 to the fifth side surface 50-5 may be tapered surfaces.

FIG. 9 is a bottom view schematically showing a modification example of the key wrench 5 in the embodiment. As seen from FIG. 9, the first side surface 50-1 is a tapered surface in which the distance from the longitudinal direction central axis L1 becomes small as heading for the tip. On the other hand, the second side surface 50-2 to the sixth side surface 50-6 are surfaces in which the distance from the longitudinal direction central axis L1 becomes small as heading for the tip. However, the taper angle (the inclination angle) of the sixth side surface 50-6 is smaller than the taper angle (the inclination angle) of the first side surface 50-1 that is the tapered surface. When the taper angle of the sixth side surface 50-6 is less than 1° or less than 0.5°, the sixth side surface 50-6 is regarded as being a non-tapered surface, in this Description.

In the example shown in FIG. 9, the rate at which the distance between the sixth side surface 50-6 and the side surface opposing to the sixth side surface 50-6 (the third side surface 50-3) decreases as heading for the tip is smaller than the rate at which the distance between the first side surface 50-1 and the side surface opposing to the first side surface 50-1 (fourth side surface 50-4) decreases as heading for the tip.

In the example shown in FIG. 9, the effect like the examples shown in FIG. 6 to FIG. 8, that is, the effect that the cam out load becomes small can be obtained. In this Description, the first taper angle as the angle between the first side surface 50-1 and the longitudinal direction central axis L1 (the first axis) may change along the longitudinal direction central axis L1. That is, even when the first taper angle changes along the longitudinal direction central axis L1, the first side surface 50-1 is regarded as the tapered surface if the first taper angle is equal to or more than 1° in the most of the first side surface 50-1.

### (When Two Tapered Surfaces Exist)

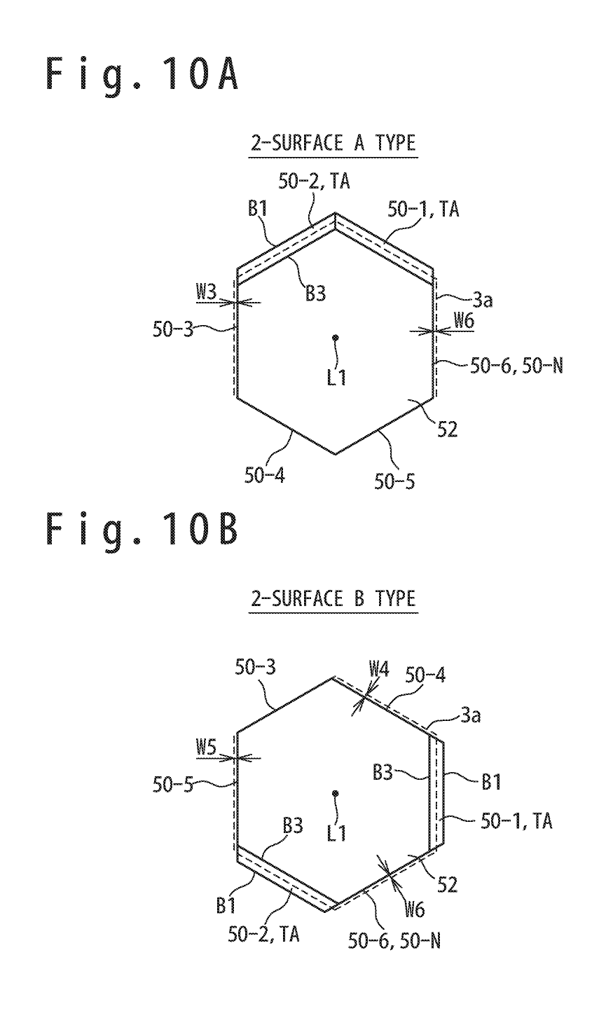

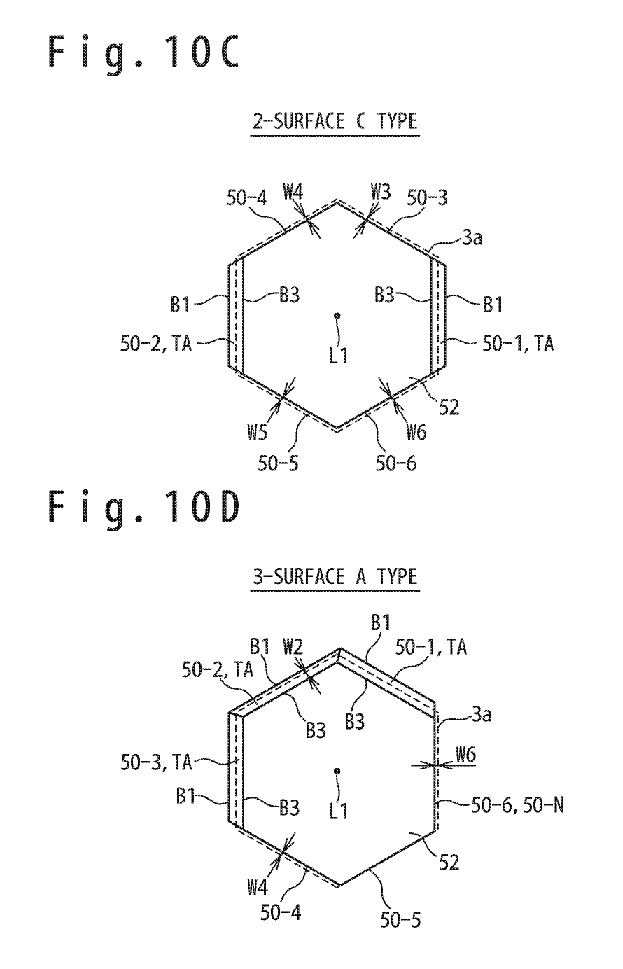

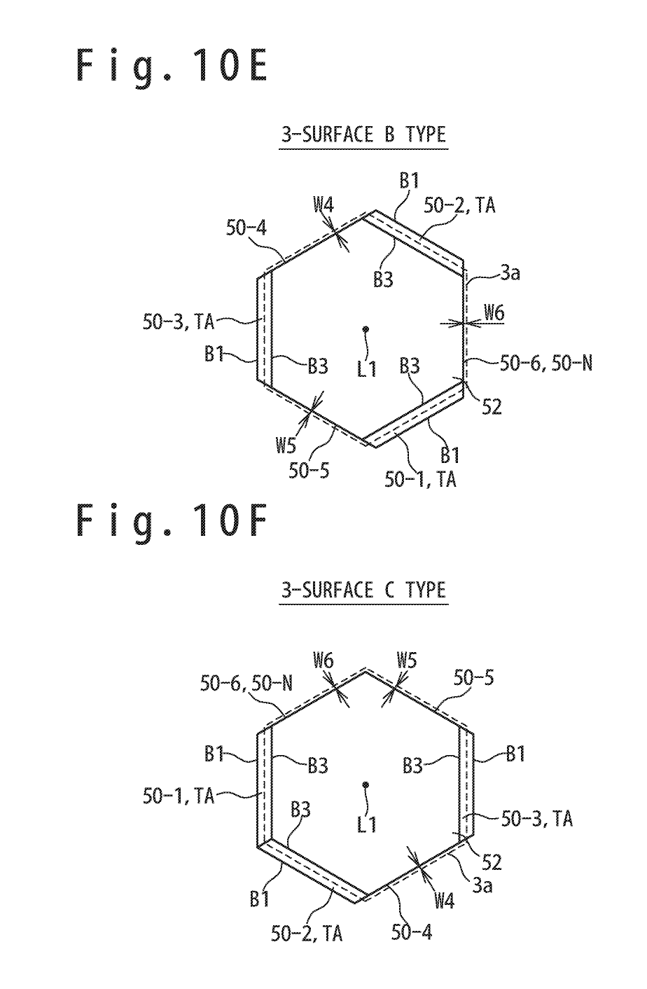

Referring to FIG. 10A to FIG. 10C, embodiments in which there are two tapered surfaces will be described. FIG. 10A to FIG. 10C are schematic bottom views of the key sections 5-2 of the key wrenches 5. The opening end edge 3a of the socket is shown virtually with a broken line in FIG. 10A to FIG. 10C.

### FIRST EXAMPLE

### 2-Surface a Type

In a first example shown in FIG. 10A, the key section 5-2 of the key wrench 5 has the first side surface 50-1 to the sixth side surface 50-6. The first side surface 50-1 and the second side surface 50-2 are tapered surfaces TA. It is desirable that the taper angle of the first side surface 50-1 is equal to or more than 1°, and the taper angle of the second side surface 50-2 is equal to or more than 1°.

The first side surface 50-1 and the second side surface 50-2 are adjacent surfaces, in other words, connected surfaces. On the other hand, each of the third side surface 50-3 to the sixth side surface 50-6 is a non-tapered surface. The taper angles of the third side surface 50-3 to the sixth side surface 50-6 are smaller than the taper angle of the first side surface 50-1 and smaller than the taper angle of the second side surface 50-2. In the first example shown in FIG. 10A, the angle between the first side surface 50-1 and the side surface opposing to the first side surface (the fourth side surface 50-4) is larger than the angle between the sixth side surface 50-6 and the side surface opposing to the sixth side surface (third side surface 50-3). In the same way, the angle between the second side surface 50-2 and the side surface opposing to the second side surface (the fifth side surface 50-5) is larger than the angle between the sixth side surface 50-6 and the side surface opposing to the sixth side surface (the third side surface 50-3).

In the first example shown in FIG. 10A, when the key section 5-2 of the key wrench 5 is inserted in the socket 2, the first side surface 50-1 that is the first tapered surface and the second side surface 50-2 that is the second tapered surface contact the opening end edge 3a of the socket. Also, the side surface opposing to the first side surface 50-1 (the fourth side surface 50-4) functions as a guide surface to contact the opening end edge 3a of the socket. In the same way, the side surface opposing to the second side surface 50-2 (the fifth side surface 50-5) function as the guide surface to contact the opening end edge 3a of the socket. On the other hand, the third side surface 50-3 and the sixth side surface 50-6 do not contact the opening end edge. In the first example shown in FIG. 10A, in the height corresponding to the opening end edge 3a of the socket, a gap W3 between the third side surface 50-3 and the opening end edge 3a is about 0.001 inches (0.025 mm), and a gap W6 between the sixth side surface 50-6 and the opening end edge 3a is about 0.001 inches (0.025 mm).

In the first example shown in FIG. 10A, in the height corresponding to the opening end edge 3a of the socket, the first side surface 50-1 and the second side surface 50-2 are located out of a virtual regular hexagon defined by the third side surface 50-3 to the sixth side surface 50-6. In other words, in the first example shown in FIG. 10A, the cross section (the cross section B1 or the cross section B2) that is perpendicular to the longitudinal direction axis of the key section 5-2 has four sides that overlap any of the six sides that configure a virtual regular hexagon (referring to 50-3, 50-4, 50-5, and 50-6 of FIG. 10A) and two sides that are located out of the virtual regular hexagon (referring to 50-1, and 50-2 of FIG. 10A). Note that the matters described in this paragraph are applied to the following second example and a third example.

In the first example shown in FIG. 10A, the two tapered surfaces exist. Therefore, the close adhesion length of the key section 5-2 and the opening end edge 3a becomes long, so that stress concentration in the surface 3 of the socket (the opening end edge 3a) is eased. As a result, the transformation of the socket 2 is restrained. Also, in the first example shown in FIG. 10A, four side surfaces of the key section contact the opening end edge 3a. Therefore, the stress concentration in the surface 3 of the socket (the opening end edge 3a) is eased. As a result, the transformation of the socket 2 is restrained.

### SECOND EXAMPLE

### 2-Surface B Type)

In a second example shown in FIG. 10B, the key section 5-2 of the key wrench 5 has the first side surface 50-1 to the sixth side surface 50-6. The first side surface 50-1 and the second side surface 50-2 are tapered surfaces TA. It is desirable that the taper angle of the first side surface 50-1 is equal to or more than 1°, and the taper angle of the second side surface 50-2 is equal to or more than 1°.

The first side surface 50-1 and the second side surface 50-2 are connected each other through the sixth side surface 50-6. In other words, the first side surface 50-1 and the second side surface 50-2 are separated from each other by the sixth side surface 50-6. On the other hand, each of the third side surface 50-3 to the sixth side surface 50-6 is a non-tapered surface. The taper angles of the third side surface 50-3 to the sixth side surface 50-6 are smaller than the taper angle of the first side surface 50-1 and smaller than the taper angle of the second side surface 50-2.

In the second example shown in FIG. 10B, when the key section 5-2 of the key wrench 5 is inserted in the socket 2, the first side surface 50-1 that is the first tapered surface and the second side surface 50-2 that is the second tapered surface contact the opening end edge 3a of the socket. Also, the third side surface 50-3 that is the side surface opposing to the sixth side surface 50-6 functions as a guide surface to contact the opening end edge 3a of the socket. On the other hand, the fourth side surface 50-4 to the sixth side surface 50-6 do not contact the opening end edge 3a. In the second example shown in FIG. 10B, in the height corresponding to the opening end edge 3a of the socket, a gap W4 between the fourth side surface 50-4 and the opening end edge 3a is about 0.0005 inches (0.013 mm), and a gap W5 between the fifth side surface 50-5 and the opening end edge 3a is about 0.0005 inches (0.013 mm). A gap W6 between the sixth side surface 50-6 and the opening end edge 3a is about 0.002 inches (0.051 mm).

In the second example shown in FIG. 10B, two tapered surfaces exist. Therefore, the close adhesion length of the key section 5-2 and the opening end edge 3a becomes long so that stress concentration in the surface 3 of the socket (the opening end edge 3a) is eased. As a result, the transformation of the socket 2 is restrained. Also, in the second example shown in FIG. 10B, three side surfaces of the key section contact the opening end edge 3a. Therefore, stress concentration in the surface 3 of the socket (the opening end edge 3a) is eased. As a result, the transformation of the socket 2 is restrained.

### THIRD EXAMPLE

### 2-Surface C Type)

In a third example shown in FIG. 10C, the key section 5-2 of the key wrench 5 has the first side surface 50-1 to the sixth side surface 50-6. The first side surface 50-1 and the second side surface 50-2 are tapered surfaces TA. It is desirable that the taper angle of the first side surface 50-1 is equal to or more than 1° and the taper angle of the second side surface 50-2 is equal to or more than 1°.

The first side surface 50-1 and the second side surface 50-2 are surfaces opposite to each other. That is, the first side surface 50-1 and the second side surface 50-2 are not directly connected. On the other hand, each of the third side surface 50-3 to the sixth side surface 50-6 is a non-tapered surface. The taper angle of each of the third side surface 50-3 to the sixth side surface 50-6 is smaller than the taper angle of the first side surface 50-1 and smaller than the taper angle of the second side surface 50-2. In the third example shown in FIG. 10C, the angle between the first side surface 50-1 and the side surface opposing to the first side surface (the second side surface 50-2) is larger than the angle between the sixth side surface 50-6 and the side surface opposing to the sixth side surface (the fourth side surface 50-4).

In the third example shown in FIG. 10C, when the key section 5-2 of the key wrench 5 is inserted in the socket 2, the first side surface 50-1 that is the first tapered surface and the second side surface 50-2 that is the second tapered surface contact the opening end edge 3a of the socket. On the other hand, the third side surface 50-3 to the sixth side surface 50-6 do not contact the opening end edge 3a. In the third example shown in FIG. 10C, in the height corresponding to the opening end edge 3a of the socket, a gap W3 between the third side surface 50-3 and the opening end edge 3a is about 0.001 inches (0.025 mm), and a gap W4 between the fourth side surface 50-4 and the opening end edge 3a is 0.001 inches (0.025 mm). A gap W5 between the fifth side surface 50-5 and the opening end edge 3a is about 0.001 inches (0.025 mm), and a gap W6 between the sixth side surface 50-6 and the opening end edge 3a is 0.001 inches (0.025 mm).

In the third example shown in FIG. 10C, two tapered surfaces exist. However, in the third example shown in FIG. 10C, only two side surfaces of the key section contact the opening end edge 3a. Therefore, an extent of the relaxation of the stress concentration in the opening end edge 3a is smaller than in the example shown in FIG. 10A or FIG. 10B.

### (When Three Tapered Surfaces Exist)

Referring to FIG. 10D to FIG. 10F, embodiments in which there are three tapered surfaces will be described. FIG. 10D to FIG. 10F are bottom views of the key sections 5-2 of the key wrenches 5. Note that the opening end edge 3a of the socket is shown virtually by a broken line in FIG. 10D to FIG. 10F.

### FOURTH EXAMPLE

### 3-Surface a Type

In a fourth example shown in FIG. 10D, the key section 5-2 of the key wrench 5 has the first side surface 50-1 to the sixth side surface 50-6. The first side surface 50-1, the second side surface 50-2 and the third side surface 50-3 are tapered surfaces TA. It is desirable that the taper angle of the first side surface 50-1 is equal to or more than 1°, the taper angle of the second side surface 50-2 is equal to or more than 1°, and the taper angle of the third side surface 50-3 is equal to or more than 1°.

The first side surface 50-1 and the second side surface 50-2 are adjacent surfaces to each other, in other words, surfaces connected to each other. Also, the second side surface 50-2 and the third side surface 50-3 are surfaces adjacent to each other, in other words, surfaces connected to each other. On the other hand, each of the fourth side surface 50-4 to the sixth side surface 50-6 is the non-tapered surface. The taper angle of each of the fourth side surface 50-4 to the sixth side surface 50-6 is smaller than the taper angle of the first side surface 50-1, smaller than the taper angle of the second side surface 50-2, and smaller than the taper angle of the third side surface 50-3.

In the fourth example shown in FIG. 10D, when the key section 5-2 of the key wrench 5 is inserted in the socket 2, the first side surface 50-1 that is the first tapered surface and the third side surface 50-3 that is the third tapered surface contact the opening end edge 3a of the socket. Also, the fifth side surface 50-5 that is the side surface opposing to the second side surface 50-2 functions as the guide surface to contact the opening end edge 3a of the socket. On the other hand, the fourth side surface 50-4 and the sixth side surface 50-6 do not contact the opening end edge 3a. In the fourth example shown in FIG. 10D, in the height corresponding to the opening end edge 3a of the socket, a gap W4 between the fourth side surface 50-4 and the opening end edge 3a is about 0.0005 inches (0.013 mm). A gap W6 between the sixth side surface 50-6 and the opening end edge 3a is about 0.0005 inches (0.013 mm). Also, in the fourth example shown in FIG. 10D, the second. side surface 50-2 that is the second tapered surface does not contact the opening end edge 3a of the socket. In the fourth example shown in FIG. 10D, in the height corresponding to the opening end edge 3a of the socket, a gap W2 between the second side surface 50-2 and the opening end edge 3a is about 0.0005inches (0.013 mm).

In the example shown in FIG. 10, in the cross section of the height corresponding to the opening end edge 3a of the socket, the first side surface 50-1 to the third side surface 50-3 are located out of the virtual regular hexagon defined by the fourth side surface 50-4 to the sixth side surface 50-6. In other words, in the fourth example shown in FIG. 10D, the cross section (the cross section B1 or the cross section B2) that is perpendicular to the longitudinal direction axis in the key section 5-2 has three sides (referring to 50-4, 50-5, and 50-6 in FIG. 10D) that overlap any of the six sides that configure a virtual regular hexagon and three sides (referring to 50-1, 50-2, and 50-3 in FIG. 10D) that are located out of the virtual regular hexagon. Note that the subject matters specified in this paragraph are applied to the following fifth and sixth examples.

The contact state of each side surface with the opening end edge 3a in the example shown in FIG. 10D is the same as the contact state of each side surface with the opening end edge 3a in the example shown in FIG. 10B. That is, in the example shown in FIG. 10D, the three side surfaces of the key section contact the opening end edge 3a. Therefore, stress concentration in the surface 3 of the socket 2 (the opening end edge 3a) is eased. As a result, the transformation of the socket 2 is restrained.

### FIFTH EXAMPLE

### 3-Surface B Type

In a fifth example shown in FIG. 10E, the key section 5-2 of the key wrench 5 has the first side surface 50-1 to the sixth side surface 50-6. The first side surface 50-1, the second side surface 50-2 and the third side surface 50-3 are tapered surfaces TA. It is desirable that the taper angle of the first side surface 50-1 is equal to or more than 1°, the taper angle of the second side surface 50-2 is equal to or more than 1°, and the taper angle of third side surface 50-3 is equal to or more than 1°.

The first side surface 50-1 and the second side surface 50-2 are connected each other through the sixth side surface 50-6. In other words, the first side surface 50-1 and the second side surface 50-2 are separated from each other by the sixth side surface 50-6. Also, the second side surface 50-2 and the third side surface 50-3 are connected each other through the fourth side surface 50-4. In other words, the second side surface 50-2 and the third side surface 50-3 are separated from each other by the fourth side surface 50-4. On the other hand, each of the fourth side surface 50-4 to the sixth side surface 50-6 is a non-tapered surface. The taper angle of each of the fourth side surface 50-4 to the sixth side surface 50-6 is smaller than the taper angle of the first side surface 50-1, is smaller than the taper angle of the second side surface 50-2, and is smaller than the taper angle of third side surface 50-3.

In the fifth example shown in FIG. 10E, when the key section 5-2 of the key wrench 5 is inserted in the socket 2, the first side surface 50-1 that is the first tapered surface, the second side surface 50-2 that is the second tapered surface and the third side surface 50-3 that is the third tapered surface contact the opening end edge 3a of the socket. On the other hand, the fourth side surface 50-4 to the sixth side surface 50-6 do not contact the opening end edge 3a. In the fifth example shown in FIG. 10E, in the height corresponding to the opening end edge 3a of the socket, a gap W4 between the fourth side surface 50-4 and the opening end edge 3a is about of 0.001 inches (0.025 mm), a gap W5 between the fifth side surface 50-5 and the opening end edge 3a is about 0.001 inches (0.025 mm), and a gap W6 between the sixth side surface 50-6 and the opening end edge 3a is about 0.001 inches (0.025 mm).

In the fifth example shown in FIG. 10E, three side surfaces of the key section contact the opening end edge 3a. Therefore, the stress concentration in the surface 3 of the socket 2 (the opening end edge 3a) is eased. As a result, the transformation of the 1b socket 2 is restrained.

### SIXTH EXAMPLE

### 3-Surface C Type

In a sixth example shown in FIG. 10F, the key section 5-2 of the key wrench 5 has the first side surface 50-1 to the sixth side surface 50-6. The first side surface 50-1, the second side surface 50-2 and the third side surface 50-3 are tapered surfaces 1A. It is desirable that the taper angle of the first side surface 50-1 is equal to or more than 1°, the taper angle of the second side surface 50-2 is equal to or more than 1°, and the taper angle of the third side surface 50-3 is equal to or more than 1°.

The first side surface 50-1 and the second side surface 50-2 are surfaces adjacent to each other, in other words, surfaces connected each other. Also, the third side surface 50-3 is the surface opposing to the first side surface 50-1 and is the surface separated from the first side surface 50-1 and the second side surface 50-2. On the other hand., each of the fourth side surface 50-4 to the sixth side surface 50-6 is a non-tapered surface. The taper angle of each of the fourth side surface 50-4 to the sixth side surface 506 is smaller than the taper angle of the first side surface 50-1, is smaller than the taper angle of the second side surface 50-2, and is smaller than the taper angle of third side surface 50-3.

In the sixth example shown in FIG. 10F, when the key section 5-2 of the key wrench 5 is inserted. In the socket 2, the first side surface 50-1 that is the first tapered surface, the second side surface 50-2 that is the second tapered surface and the third side surface 50-3 that is the third tapered surface contact the opening end edge 3a of the socket. On the other hand, the fourth side surface 50-4 to the sixth side surface 50-6 do not contact the opening end edge 3a. In the sixth example shown in FIG. 10F, in the height corresponding to the opening end edge 3a of the socket, a gap W4 between the fourth side surface 50-4 and the opening end edge 3a is about 0.001 inches (0.025 mm), a gap W5 between the fifth side surface 50-5 and the opening end edge 3a is about 0.001 inches (0.025 mm), and a gap W6 between the sixth side surface 506 and the opening end edge 3a is about 0.001 inches (0.025 mm)

In the sixth example shown in FIG. 10F, the three side surfaces contact the opening end edge 3a. Therefore, the stress concentration in the surface 3 of the socket 2 (the opening end edge 3a) is eased. As a result, the transformation of the socket 2 is restrained.

### (Application Example of Key Wrench in Embodiment)

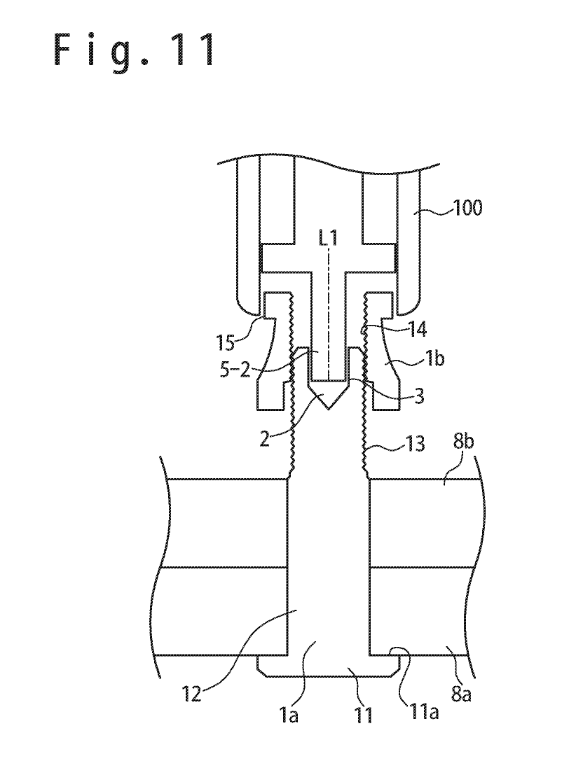

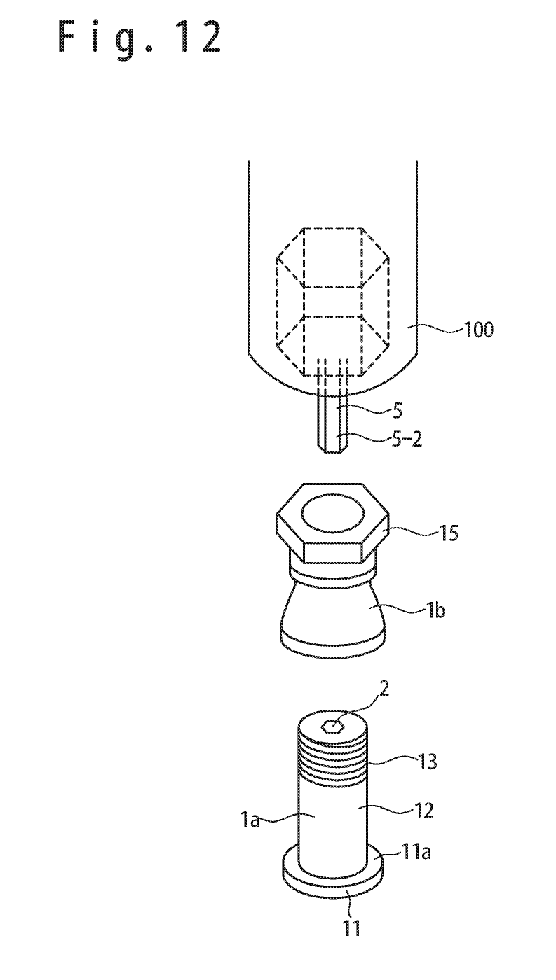

Referring to FIG. 11 and FIG. 12, an application example of the key wrench will be described. FIG. 11 is a longitudinal cross-sectional view showing the application example of the key wrench. FIG. 12 is a schematic perspective view showing the application example of the key wrench. In FIG. 12, the illustration of the fastened member is omitted.

FIG. 11 shows a situation in which a fastened member 8a and a fastened member 8b are fastened by using the bolt 1a that is a fastening member 1 and the nut 1b. Each of the fastened member 8a and the fastened member 8b may be a board member. The fastening member 1 (the bolt 1a) has the socket 2 in which the key section 5-2 of the key wrench in the embodiment is inserted. The socket 2 is opened for an upper direction.

In the example shown in FIG. 11 and FIG. 12, the bolt 1a has a head section 11 and an axis section 12. A surface 11a of the head section 11 on the side of axis section contacts the fastened member 8a. The axis section 12 has the socket 2 in the center of the distal end. In other words, the socket 2 is provided in the end surface (a distal surface) of the axis section 12. Also, a first thread 13 is provided on the outer circumferential surface of the axis section 12.

The nut 1b has a second thread 14 to screw the first thread 13 of the bolt. Also, the outer circumferential surface 15 of the nut 1b has the shape engageable with a tool 100 (for example, the polygonal shape in the cross section).

Referring to FIG. 11, a method of fastening the fastened members 8a and 8b by the bolt 1a and the nut 1b will be described. At a first step, the bolt 1a is inserted in the holes of the fastened members 8a and 8b. At a second step, the nut 1b is temporarily attached to the bolt 1a. At a third step, the key section 5-2 of the key wrench in the embodiment is inserted in the socket 2 provided for the the axis section of the bolt. The key section 5-2 is inserted in the socket 2 so that the rotation of the bolt 1a around the bolt central axis is prevented. At a fourth step, the tool 100 is engaged with the outer circumferential surface 15 of the nut 1b.

At a fifth step, the tool 100 is rotated (more specifically, the engaging part of the tool 100 with the outer circumferential surface 15 of the nut 1b is rotated) in a condition that the rotation of the bolt 1a is restrained by the key wrench 5 so that the nut 1b moves for the head of the bolt 1a (screwed to the bolt 1a). At a sixth step, the fastened members 8a and 8b are supported between the the head section 11 of the bolt and the nut 1b. That is, the fastened members 8a and 8b are fastened by the bolt 1a and the nut 1b. Note that the rotation of the tool 100 may be carried out by manpower or may be carried out using power.

Since the key section 5-2 of the key wrench in the embodiment has the side surface (the first side surface 50-1) that is the tapered surface, the stress concentration in the surface 3 defining the socket 2 is restrained. Also, the key section 5-2 has the side surface (the sixth side surface 50-6) that is the non-tapered surface. Therefore, the cam out load does not become excessive. As a result, the screwing process of the nut 1b to the bolt 1a can be more smoothly executed. Note that the key wrench may be either of the key wrenches in the above-mentioned first example to sixth example.

Generally, the size of the socket 2 provided for the axis section 12 of the bolt is quite small. Therefore, the relatively large load acts on the key section that has been inserted in the socket 2 provided for the axis section 12 of the bolt. As a result, the stress concentration in the surface 3 defining the socket 2 tends to become large. On the other hand, when attempting to ease stress concentration by using the key section in which all of the side surfaces are tapered surfaces, the cam out load tends to become large. However, in case where the key wrench in the embodiment (the key wrench having the first side surface that is the tapered surface and the sixth side that is the non-tapered surface) is used, the problem of the stress concentration and the problem of the cam out load can be collectively solved. In other words, in the key wrench of the embodiment, the effect of the relaxation of the stress concentration and the effect of the restraint of the cam out load are played synergistically.

### (Experiment Example and Analysis Example)

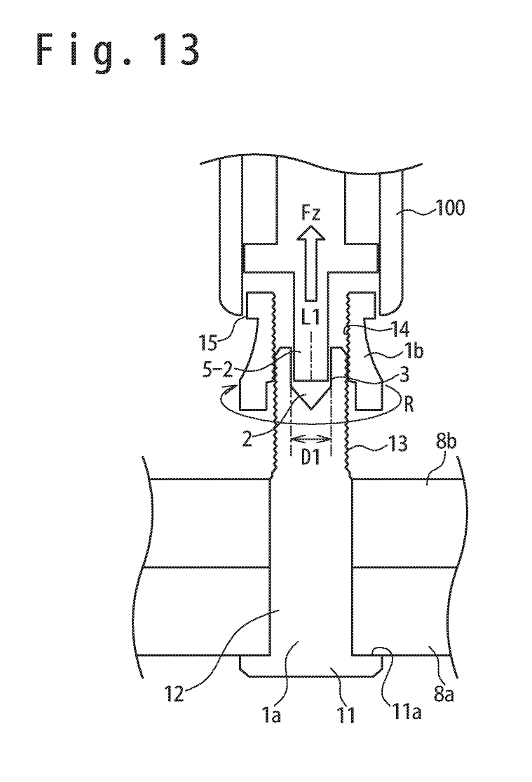

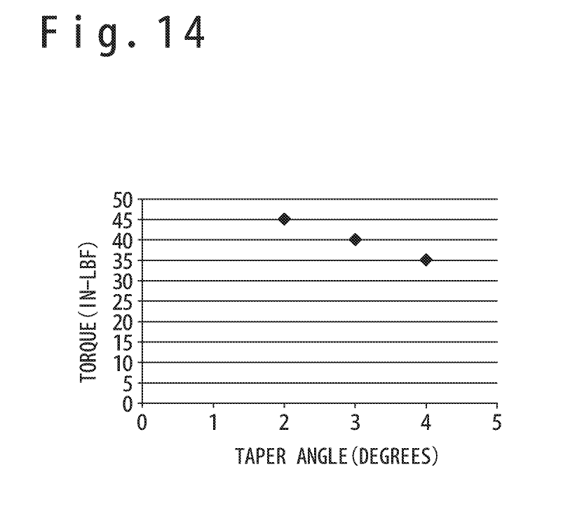

An experiment was carried out by using the apparatus shown in FIG. 13. A distance D1 between the opposing side surfaces of the socket 2 was 3/32 inches (about 2.38 mm). Also, the torque acting on the key section 5-2 was measured when the nut 1b is screwed to the bolt 1a by rotating the nut 1b to the R direction.

FIG. 14 shows an analysis result of torque when the socket is destroyed in case that all the six side surfaces of the key section 5-2 are tapered surfaces, and moreover, the taper angles of all the side surfaces are equal to each other. That is, FIG. 14 shows an analysis result to the key wrench in a comparison example. Referring to FIG. 14, when the taper angle θ of the side surface was 2°, the socket 2 was destroyed upon about 45 inch pound (5.1 N.m). Note that the fact that the socket was destroyed means that the ability of the socket to maintain a torque was lost substantively. Also, when the taper angle of the side surface was 3°, the socket 2 was destroyed upon about 40 inch pound (4.5 N.m). Also, when the taper angle of the side surface was 4°, the socket 2 was destroyed upon about 35 inch pound (4.0 N.m).

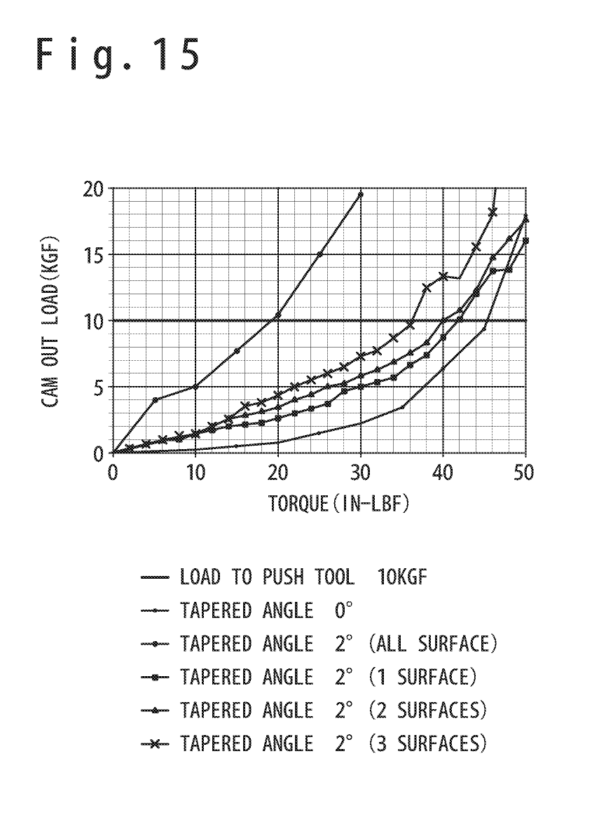

FIG. 15 shows an analysis result of calculated cam out load Fz of the key section 5-2:
(1) when all the side surfaces are non-tapered surfaces,
(2) when all the side surfaces are tapered surfaces,
(3) when only one side surface is a tapered surface,
(4) when only two side surfaces are tapered surfaces, and
(5) when only three side surfaces are tapered surfaces,
   in shape of six side surfaces of the key section 5-2. The cam out load Fz means the upward load received by the key section 5-2, as shown in FIG. 13.

Referring to FIG. 15, in case that all of the six side surfaces of the key section 5-2 were non-tapered surfaces (corresponding to “the taper angle of 0°” in the graph of FIG. 15), the cam out load was 10 kgf when the torque acting on the key section 5-2 was about 45 inch pound (5.1 N.m). In other words, when the torque acting on the key section 5-2 was about 45 inch pound (5.1 N.m), it became impossible to restrain the cam out of the key section 5-2 with the downward holding force of 10 kgf. Also, in case that all of the six side surfaces of the key section 5-2 were tapered surfaces, the cam out load became 10 kgf when the torque acting on the key section 5-2 was about 19 inch pound (2.1 N.m). Also, in case that the six side surfaces of the key section 5-2 contain one, two or three tapered surfaces, the cam out load became 10 kgf when the torque acting on the key section 5-2 was about 36 to 42 inch pound (4.1 to 4.7 N.m).

As above, when the six side surfaces of the key section 5-2 contain only one tapered surface, only two tapered surfaces or only three tapered surfaces, the cam out can be effectively restrained, compared with a case that all the six side surfaces were tapered surfaces.

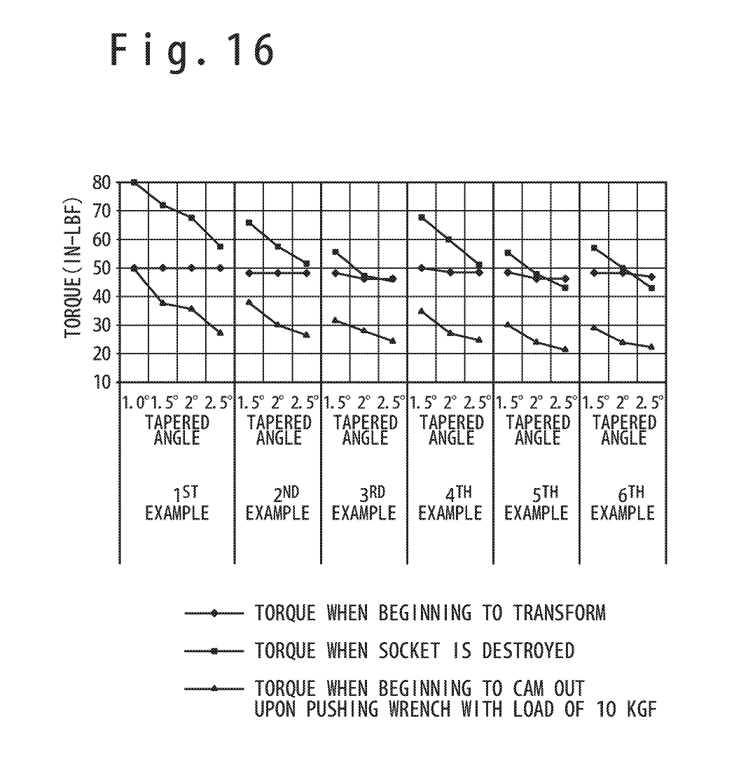

FIG. 16 shows an analysis result of, the torque when the surface 3 of the socket 2 begins to transform, (B) the torque when the socket 2 is destroyed, and (C) the torque when the key section 5-2 begins to cam out, in case that the shape of key section 5-2 is (1) the shape corresponding to the above-mentioned first example, (2) the shape corresponding to the above-mentioned second example, (3) the shape corresponding to the above-mentioned third example, (4) the shape corresponding to the above-mentioned fourth example, (5) the shape corresponding to the above-mentioned fifth example, and (6) the shape corresponding to the above-mentioned sixth example. Regarding the above-mentioned “(C)”, the torque means the torque when the key section 5-2 begins to cam out, in a state that the key section 5-2 is pressed in the load of 10 kgf.

Referring to FIG. 16, the cam out was effectively restrained in any of the first example to the sixth example, even when the relatively large torque acted on the key section 5-2. When it was desired to make the torque when the key section 5-2 begun to cam out larger, the taper angle should be made small. In other words, from the viewpoint of the cam out being restrained, it is desirable that, for example, the taper angle is equal to or less than 2.5°, equal to or less than 2.0° or equal to or less than 1.5°. On the other hand, when the taper angle is smaller than 1.0°, the risk increases that the free end of the key section 5-2 pushes against the bottom surface of the socket 2. When the free end of the key section 5-2 pushes against the bottom surface of the socket 2, the tapered surface cannot contact the opening end edge 3a of the socket appropriately. As a result, the large stress concentration occurs in a contact part between the key section 5-2 and the surface 3 of the socket. Therefore, it is desirable that the taper angle is equal to or more than 1.0°.

Referring to FIG. 16, there is not a conspicuous difference among the first example to the sixth example as for the torque when the socket begins to transform.

Regarding the torque when the socket is destroyed, it is understood that the key wrench in the first example to the sixth example is more excellent than the key wrench in a comparison example shown in FIG. 14. The first example, the second example, and the fourth example are excellent among the first example to the sixth example. Also, referring to FIG. 16, if the torque when the socket is destroyed should be made larger, it could be understood that the taper angle should be made small. Especially, when the taper angle is from 1° to 2.5° in the first example, the second example and the fourth example, the torque when the socket is destroyed exceeds 50 inch pound (about 5.5 Nm). Also, when the taper angle is from 1° to 2° in the first example and the fourth example, the torque when the socket is destroyed exceeds 60 inch pound (about 6.6 Nm).

From the above viewpoint, regarding the torque when the socket is destroyed in case where the number of tapered surfaces is two, it is desirable that the two tapered surfaces are adjacent to each other as in the first example (in other words, the first side surface 50-1 that is the tapered surface and the second side surface 50-2 that is the tapered surface are adjacent to each other), or it is desirable that the two tapered surfaces are connected to each other through one non-tapered surface as in the second example (in other words, the first side surface 50-1 that is the tapered surface and the second side surface 50-2 that is the tapered surface are connected to each other through the sixth side surface 50-6 that is the non-tapered surface). Also, regarding the torque when the socket is destroyed., the case that the two tapered surfaces are adjacent to each other (the first example) is the most desirable. On the other hand, when the number of tapered surfaces is three, it is desirable that the three tapered surfaces are continuous as in the fourth example (in other words, the first side surface 50-1 that is the tapered surface and the second side surface 50-2 that is the tapered surface are adjacent to each other, and the second side surface 50-2 that is the tapered surface and the third side surface 50-3 that is the tapered surface are adjacent to each other). Moreover, regarding the torque when the socket is destroyed, it is desirable that the taper angle is from 1° to 2.5°, especially, from 1° of to 2°.

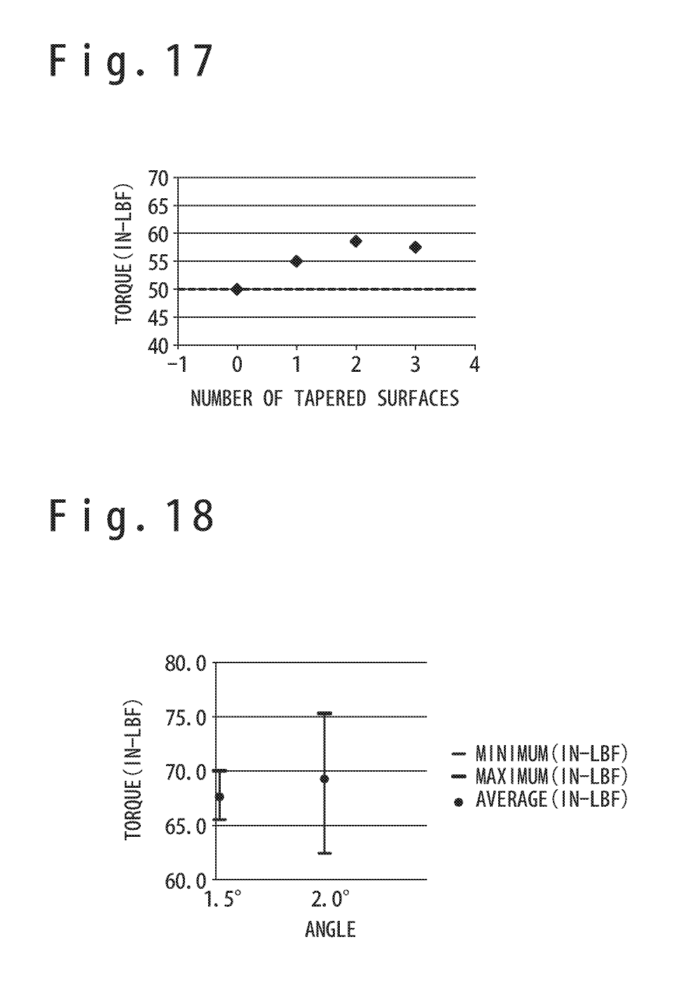

FIG. 17 shows an experiment result of an average of the torque when the socket 2 is destroyed in:
(1) when all the side surfaces are non-tapered surfaces,
(2) when only one side surface is a tapered surface,
(3) when only two side surfaces are tapered surfaces, and
(4) when only three side surfaces are tapered surfaces,
   about the six side surfaces of the key section 5-2.

Referring to FIG. 17, it is most desirable that the number of tapered surfaces is two. It is next desirable that the number of tapered surfaces is three.

FIG. 18 shows the experiment result of the torque when the socket 2 is destroyed, in each of: (1) a case where the shape of the key section 5-2 is a shape corresponding to the above-mentioned first example and moreover the taper angle is 1.5°, and (2) a case where the shape of the key section 5-2 is a shape corresponding to the above-mentioned first example and moreover the taper angle is 2.0° . Referring to FIG. 18, a conspicuous difference depending on the taper angle was not found about the first example, regarding the torque when the socket is destroyed.

When determining the analysis result and the experiment result comprehensively, it is desirable that the number of tapered surfaces is two or three rather than one, and especially, it is desirable that the number of tapered surfaces is two. Also, it is desirable that the taper angle of the tapered surface is from 1° to 2.5°, especially, it is desirable that the taper angle is from 1° to 2° or 1.5° to 2°. Regarding the arrangement of a plurality of tapered surfaces, it is desirable that the plurality of tapered surfaces are arranged in the neighborhood (for example, the first side surface that is the tapered surface and the second side surface that is the tapered surface are adjacent to each other).

The present invention is not limited to the above embodiments. It would be understood that each of the embodiments may be changed or modified appropriately in the range of the technical thought of the present invention. Various techniques used in each embodiment or modification can be applied to another embodiment or modification, unless the technical contradiction occurs.

The present patent application is based on Japan Patent Application JP 2016-085373, and also claims a priority based on the Patent Application. The disclosure of the Patent Application is incorporated herein by reference.

1. A key wrench comprising:
a key section engageable with a socket of an N-sided polygon when N is an optional natural number equal to or more than 3; and
a proximal section,
wherein the key section has N side surfaces that contain a first side surface, a second side surface and an N^{th} side surface,
wherein the first side surface is a tapered surface, and a length of the tapered surface is longer than a depth of the socket into which the key section is to be inserted, and wherein the N^{th} side surface is a non-tapered surface.

2. The key wrench according to claim 1, wherein the key section contains a third side surface,
wherein at least one of the second side surface and the third side surface is a tapered surface, and
wherein the N side surfaces other than the first side surface, the second side surface and the third side surface are the non-tapered surfaces.

3. The key wrench according to claim 2, wherein the second side surface is the tapered surface and the third side surface is the non-tapered surface.

4. The key wrench according to claim 2, wherein the second side surface is the tapered surface, and
wherein the first side surface that is the tapered surface and the second side surface that is the tapered surface are adjacent to each other.

5. The key wrench according to claim 1, wherein a taper angle of the first side surface is from 1° to 2.5°.

6. The key wrench according to claim 1, wherein a cross section of the key section that is perpendicular to a longitudinal direction axis contains two or more sides that overlap any of the N sides of a virtual regular N-sided polygon, and at least one side that is located out of the virtual regular N-sided polygon.

7. (canceled)
